(19) United States
(12) Patent Application Publication
(10) Pub. No.: US 2025/0094138 A1
(43) Pub. Date: Mar. 20, 2025

(54) LLM FINE-TUNING FOR CODE GENERATION

(71) Applicant: ORACLE INTERNATIONAL CORPORATION, Redwood Shores, CA (US)

(72) Inventors: Yazhe HU, Bellevue, WA (US); Mengqing GUO, Issaquah, WA (US); Zheng WANG, Sammamish, WA (US); Tao SHENG, Bellevue, WA (US); Jun QIAN, Newcastle, WA (US); Vinod MAMTANI, Bellevue, WA (US)

(21) Appl. No.: 18/743,866

(22) Filed: Jun. 14, 2024

Related U.S. Application Data
(60) Provisional application No. 63/538,663, filed on Sep. 15, 2023.

(51) Int. Cl. G06F 8/35; G06N 3/0895

(52) U.S. Cl. CPC G06F 8/35; G06N 3/0895

(57) ABSTRACT

Systems, methods, and other embodiments associated with automated fine-tuning of software code generation by large language models are described herein. In one embodiment, a method accesses a collection of software code samples that intermix sample code and human language description. The method generates prompts to an LLM to write code that performs as described by the human language description of the sample code. The method fine-tunes a large language model to generate software code based on a code generation loss function that evaluates code generated by the LLM in response to the prompts. The method generates an evaluation score for performance of the tuned large language model as a code generator based on code generation loss for second generated code. And, the method automatically signals that fine-tuning of the tuned large language is complete in response to the evaluation score satisfying a threshold.

### CROSS REFERENCE TO RELATED APPLICATIONS

This disclosure claims the benefit of U.S. Provisional Patent Application Ser. No. “63/538,663” filed Sep. 15, 2023, titled “Large Language Model Fine Tuning”, having inventors: Yazhe H U, Zheng WANG, Mengqing GUO, Tao SHENG, Jun QIAN, and Vinod MAMTANI, and assigned to the present assignee, the entirety of which application is incorporated by reference herein in its entirety.

### BACKGROUND

A large language model (LLM) is an artificial intelligence system that has been trained on vast amounts of text data to generate appropriate text responses to human language prompts. A LLM is capable of performing many diverse tasks, such as software code generation. It is not currently possible to automatically evaluate and improve the performance of the LLM for software code generation.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a code generation tuning system associated with automated LLM fine-tuning for software code generation.

FIG. 2 illustrates an example code generation tuning pipeline for automated fine-tuning of LLM software code generation.

FIG. 3 illustrates one embodiment of a code generation tuning method associated with automated LLM fine-tuning for software code generation.

FIG. 4 illustrates an embodiment of a computing system configured with the example systems and/or methods disclosed.

### DETAILED DESCRIPTION

Systems, methods, and other embodiments are described herein that provide automated fine-tuning of software code generation by large language models (LLMs). In one embodiment, a code generation tuning system automatically fine-tunes an LLM to improve performance of software code generation by the LLM. For example, the code generation tuning system automatically adjusts the LLM to cause the LLM to generate outputs that are more closely aligned with expectations for generating a body of software code in response to natural language requirements or instructions to the LLM. And, for example, the code generation tuning system automatically evaluates improvement of LLM code generation performance in order to control deployment of the improved LLM to a production environment. In one embodiment, the LLM code generation tuning system quantifies improvement to the performance of the LLM at the task of software code generation, rendering the improvement verifiable.

In one embodiment, the code generation tuning system implements a pipeline for LLM fine-tuning on code generation tasks. In one embodiment, the code generation tuning system is a clear improvement over traditional techniques for LLM fine-tuning to improve code generation performance. Unlike traditional techniques which use prompt engineering or in-context learning to improve code generation ability of an LLM, in one embodiment, the code generation tuning system integrates use of specialized code generation training data with automated evaluation of iterative improvement to the LLM. In one embodiment, the pipeline implemented by the code generation tuning system uses customized code generation training data to fine-tune LLM weights for optimized code generation performance. Meanwhile, the pipeline uses automatic evaluation of the code generation to iteratively analyze the improvement/degradation of the fine-tuned LLM in order to obtain improved (e.g., optimized) LLM weights for code generation. In one embodiment, the code generation tuning system automatically evaluates and analyzes the ability of the LLM to generate valid software code that accurately reflects tasks specified in a natural language prompt, thereby removing dependence on manual review of generated code for verification of the improvement and deployment decisioning.

Thus, in one advantageous improvement, the use of golden samples of code labeled with human-written, human language prompts that cause the golden sample to be generated is removed entirely from a high-volume training phase of the fine-tuning process, and restricted entirely to a low-volume testing or validation phase of the fine-tuning process. In the training phase, the description used for the prompt is supplied by automatically extracting and reformatting the pre-existing comments to the training code itself.

### Definitions

As used herein, the term “fine-tuning” refers to the process of taking a pre-trained LLM and further training it on a specific task or domain—such as generation of software code—using a dataset that is targeted to the specific task or domain.

As used herein, the term “software code” (or just “code”, for short) refers to a set of instructions written in a code language that is designed to be executed by a computer system. The software code instructs the computer system how to perform specific tasks, such as processing data, performing calculations, or interacting with hardware and other software. The term software code includes (but is not limited to): (1) source code—human-readable instructions written by programmers that are compiled into object code by a compiler for subsequent execution; (2) scripts—human-readable instructions written by programmers that are read and performed by an interpreter, for example at runtime; (3) object code—machine-readable instructions (e.g., directly-executable binary instructions) generated from source code by a compiler; (4) markup code—instructions written to structure and format content of a document or other data; (5) database code—instructions written for interacting with databases; (6) configuration code—instructions defining settings and parameters for software applications and systems; (7) data serialization code—instructions written to convert data structures to and from formats that can be stored or transmitted; and various domain specific languages tailored to a particular application domain. Software code may be written in a wide variety of code languages. Example code languages include Java, C, C++, C#, .NET, Python, JavaScript, Ruby, PHP, Swift, Go, Rust, Kotlin, COBOL, Visual Basic, Graal, JavaScript, Bash (Shell Script), PowerShell, Lua, R, Tcl, VBScript, machine code, bytecode (such as Java byte code, .NET intermediate language, and Python bytecode), XML, HTML, LaTex, cascading style sheets, YAML, scalable vector graphics (SVG), SQL (including various extensions such as PL/SQL, T-SQL, PL/pgSQL), various NOSQL languages, MongoDB, Cassandra, Gremlin, Cypher, JSON, SOAP, Protobuf, Avro, MATLAB, RegEx, and many others.

As used herein, the term “human language” (or “natural language”) refers to a language that is used among humans for linguistic communication, such as a language that people use in everyday conversations, reading, and writing. Example natural languages include English, Spanish, Mandarin, Hindi, Arabic, and a wide variety of others. For purposes of this application, the terms include classical languages such as Latin, Sanskrit, and Literary Chinese, and constructed or auxiliary languages such as Esperanto and Interlingua.

As used herein, the term “recall” refers to an extent to which terms, operators, words (or other tokens), or phrases from a reference or sample text (such as software code) also appear in an LLM-generated text (such as software). More formally, recall indicates a proportion of relevant items in a first text that also occur in a second text.

As used herein, the term “precision” refers to an extent to which terms, operators, words, or other tokens appear in the same order in both a reference or sample text and an LLM-generated text. Precision thus indicates a proportion of items in the LLM-generated text that preserve meanings expressed in the reference text.

It should be understood that no action or function described or claimed herein is performed by the human mind. No action or function described or claimed herein can be practically performed in the human mind. An interpretation that any action or function described or claimed herein can be performed in the human mind is inconsistent with and contrary to this disclosure.

### Example Code Generation Tuning System for LLMs

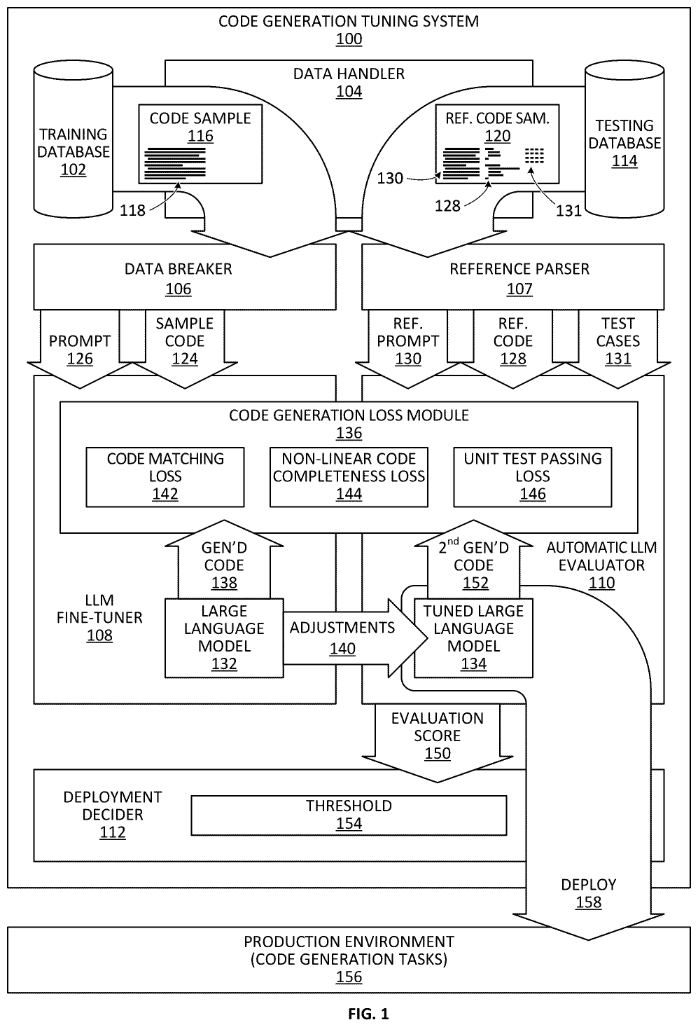

FIG. 1 illustrates one embodiment of a code generation tuning system 100 associated with automated LLM fine-tuning for software code generation. Code generation tuning system 100 includes components for (i) automatically fine-tuning a LLM to generate outputs that more closely track expected software code responses to human language prompts that describe software functionality, (ii) automatically testing the extent to which the performance of the LLM has improved at the task of software code generation using a golden benchmarking dataset of code samples that are specially chosen as examples due to quality of the software code and accuracy of human language description of the code in comments to the code. In one embodiment, the components of code generation tuning system 100 include training database 102, data handler 104, data breaker 106, reference parser 107, LLM fine-tuner 108, automatic LLM evaluator 110, deployment decider 112, and testing database 114.

In one embodiment, data handler 104 is configured to access collections of software code samples. In one collection—a training database 102 of code samples used for training an LLM—individual software code samples (code samples 116) include intermixed sample code and human language description of the sample code. In another collection—a testing database 114 of code samples used for testing the LLM once trained—individual software code samples (reference code samples 120) include discrete reference code, a reference prompt, and test case(s). In one embodiment, to access either collection, data handler 104 is configured to establish a connection to a database that holds the collection of software code samples, execute queries that retrieve the software code samples from the database, and store the retrieved software code samples for subsequent access and analysis by other portions of code generation tuning system 100. For example, data handler 104 may be configured to temporarily store or cache code samples 116 until they are collected by data breaker 106 or reference parser 107.

In one embodiment, data handler 104 provides an interface or API by which other components or modules may access the software code samples, for example by returning the software code samples to a requesting component, or exposing the software code samples for retrieval by particular components. Data handler 104 is configured to pass the code samples 116 from training database 102 to data breaker 106. And, data handler 104 is configured to pass the reference code samples 120 from testing database 114 to reference parser 107. In short, data handler 104 is configured to collect software code samples and make them available to other components for subsequent processing and use.

In one embodiment, data handler 104 is configured to access a collection of code samples 116 in training database 102. Code samples 116 are configured to be used for training an LLM for improved code generation performance, as described herein. A code sample 116 includes intermixed code and description 118. The intermixed code and description 118 includes sample code and a human language description of the sample code. The sample code is operable code for performing one or more tasks, such as a function, module, or other program component. The human language description may be comment(s) or other natural language that explain features and functions of the sample. The human language description is written in natural language. In one embodiment, the code samples 116 are collected into training database 102 from one or more codebases or libraries.

In one embodiment, data handler 104 is also configured to access a collection of reference code samples 120 in the testing database 114. Reference code samples 120 are configured to be used for evaluating an LLM for improved code generation performance, as described herein. The reference code samples 120 from testing database 114 are designated as “golden” samples. The reference code samples 120 serve as benchmarks for evaluating the success of LLM fine-tuning to improve code generation performance. In one embodiment, unlike code samples 116, reference code samples 120 do not include intermixed code and description. Instead, reference code samples 120 are in a format similar to that shown below in Table 1. Here, an individual reference code sample 120 includes a reference prompt 130, reference code 128, and one or more test cases 131. In one embodiment, reference prompt 130 is pre-written, for example by a human, to request software code with a specified functionality from an LLM. In one embodiment, reference code 128 is pre-written, for example by a human, to embody the specified functionality of the reference prompt 130. The reference code 128 is code that is considered to conform well to the human-language requirements of reference prompt 130. And, in one embodiment, test case(s) 131 are inputs to a unit test of code generated in response to the reference prompt 130.

In one embodiment, data breaker 106 is configured to generate prompts to an LLM to write code that performs as described by the human language description of the sample code. For example, data breaker 106 is configured to parse code samples 116 to separate human language descriptions of software functionality from the actual software code, and then reformat the human language descriptions as prompts to an LLM for generating code. At a high level, data breaker 106 is configured to separate comments describing the function of the sample code from the sample code 124, and to create, from the extracted comments, prompts 126 to an LLM to generate code that performs the function.

In one embodiment, data breaker 106 is configured to parse a code sample 116 to identify the sample code 124 and the human language description of the sample code. In one embodiment, data breaker 106 is further configured to automatically identify a target programming language (or coding language) from the sample code. Data breaker 106 may store the sample code 124 and the human language description (and, where applicable, the target programming language) in respective data structures.

In one embodiment, data breaker 106 is configured to then convert the human language description of the sample code 124 into a prompt 126. The prompt 126 is configured to cause an LLM to respond with generated code that, when executed, performs the functions described by the human language description. In one embodiment, data breaker 106 is configured to populate a template prompt with the human language description of the functionality of the sample code 124 in order to produce the prompt 126. In one embodiment, data breaker 106 is further configured to include the target programming language in the prompt. Data breaker 106 may store the prompt 126 in a data structure that is associated with the data structure for the sample code 124.

In one embodiment, data breaker 106 is configured to transmit or otherwise pass sample code 124 and prompt 126 to LLM fine tuner 108, where sample code 124 and prompt 126 may be used in operations to fine-tune the code generation performance of a large language model (LLM) 132 by further training.

In one embodiment, reference parser 107 is configured to parse reference code samples to extract the reference prompt 130, reference code 128, and test cases 131 from the data structure of the reference code sample 120. Reference parser 107 is configured to pass or otherwise make available to automatic LLM evaluator 110 a set of corresponding reference prompt 130, reference code 128, and test cases 131 from one reference code sample 120. The set of associated reference code 128, reference prompt 130, and test case(s) 131 may be used by automatic LLM evaluator in operations to evaluate the state of fine-tuning for the tuned LLM 134.

In one embodiment, LLM fine-tuner 108 is configured to fine-tune a large language model 132 to generate software code based on a code generation loss module 136. The code generation loss module 136 evaluates generated code 138 that is generated by the LLM 132 in response to the prompts 126. LLM-fine tuner 108 is configured to generate adjustments 140 to weights (and/or other parameters) of large language model 130 based on code generation loss module 136. For example, LLM fine-tuner 108 is configured to update, adjust, optimize, further train, or otherwise fine-tune LLM 132 so as to improve performance of LLM 132 at the task of software code generation, as measured by the code generation loss module 136. In other words, LLM fine-tuner 108 is equipped to tailor a configuration of LLM 132 to reduce software code generation loss, improving the accuracy of generation of software code by the LLM 132 from human language prompts.

In one embodiment, LLM fine tuner 108 is configured to generate adjustments 140 that improve code generation by LLM 132 based on one or more pairs of sample code 124 and associated prompt 126 generated from the intermixed code and description of a code sample 116. LLM fine tuner 108 is configured to produce adjustments 140 to large language model 130 so as to optimize (e.g., minimize) code generation loss module 136 over the course of training. LLM fine tuner 108 is configured to generate adjustments 140 to the weights (and/or other parameters) of LLM 132 by backpropagation. LLM fine-tuner 108 is configured to iteratively adjust weights of LLM 132 in response to individual pairs of sample code 124 and prompt 126 over an epoch of training. The epoch of training includes one or more pairs of corresponding sample code 124 and prompt 126 extracted from code samples 116. Note, a sample code and prompt may be said to “correspond” where both are extracted from a same code sample. The adjustments 140 may thus be a series of updates or changes to weights of nodes of the LLM 132 (or other parameters). LLM fine tuner 108 is configured to apply the adjustments 140 to the LLM 132 to create a re-trained, updated, or otherwise “tuned” LLM 134 at the end of an epoch of training. LLM fine-tuner 108 submits the tuned LLM 134 to automatic LLM evaluator 110 for evaluation of the ability of tuned LLM 134 to generate code.

In one embodiment, code generation loss module 136 is configured to penalize dissimilarity of generated code with the sample code, incompleteness of the generated code, and inoperability of the generated code. In one embodiment, a code generation loss module 136 module includes sub-modules for code matching loss module 142, non-linear code completeness loss module 144, and unit test passing loss module 146. These individual loss analyses generate components values of the code generation loss module 136. Code generation loss module 136 is configured to combine loss values of the code matching loss module 142, non-linear code completeness loss module 144, and unit test passing loss module 146 analyses for an individual instance of LLM-generated code 138 to produce an overall value of code generation loss for the instance of LLM-generated code 138. In one embodiment, code generation loss module 136 is configured to combine code matching loss module 142, non-linear code completeness loss module 144, and unit test passing loss module 146 in a weighted average.

In one embodiment, code matching loss module 142 is configured to determine whether and/or to quantify an extent to which the generated code 138 is dissimilar to the sample code 124 that is associated with the prompt 126 from which the generated code 138 was produced. For example, code matching loss module 142 may determine the extent of dissimilarity based on recall between sample code 124 and generated code 138. And, code matching loss module 142 may determine the extent of dissimilarity based on precision between sample code 124 and generated code 138. Code matching loss module 142 is configured to normalize and combine the values of recall and precision (for example, by a weighted average) to produce a value of code matching loss module 142 for the generated code 138.

In one embodiment, non-linear code completeness loss module 144 is configured to determine whether and/or to quantify an extent to which the generated code 138, when executed, fails to produce expected output on a line-by-line basis. For example, non-linear code completeness loss module 144 is configured to access a test case for the sample code, for example, a test case including appropriate values for input values of the sample code 124. The test case may be automatically generated, for example by Monte Carlo simulation of the input values. Non-linear code completeness loss module 144 is configured to execute the sample code 124 and the generated code 138 on the test case, and record, line-by-line the intermediate results of each line. Non-linear code completeness loss module 144 is configured to compare the intermediate result outputs from the sample code 124 and the generated code 138 at each line. Where the outputs of a line differ for the sample code 124 and the generated code 138, non-linear code completeness loss module 144 is configured to increase the value of loss based on how early the line is in the overall code. In one embodiment, non-linear code completeness loss module 144 is configured to penalize incorrect output of earlier lines of the generated code 138 more heavily than incorrect output of later lines of the generated code 138.

In one embodiment, unit test passing loss module 146 is configured to determine whether and/or to quantify an extent to which the generated code 138, when executed, fails to produce output consistent with the sample code 124. In other words, unit test passing loss module 146 is configured to determine whether the generated code 138 performs a same function of the sample code 124. For example, unit test passing loss module 146 is configured to access a test case for the sample code, for example, a test case including appropriate values for input values of the sample code 124. Again, the test case may be automatically generated, for example by Monte Carlo simulation of the input values. Unit test passing loss module 146 is configured to execute the sample code 124 and the generated code 138 on the test case, and record the final results of executing each of the sample code 124 and the generated code 138 for the test case.

Unit test passing loss module 146 is configured to compare the final results from the sample code 124 and the generated code 138. In one embodiment, the unit test passing loss is binary for individual test cases: either the final results match, and there is no unit test passing loss (e.g., unit test passing loss is equal to 0); or the final results do not match, and the unit test passing loss is total (e.g., unit test passing loss is equal to 1 or some other value indicative of failure of the unit test). Where the final results differ for the sample code 124 and the generated code 138, unit test passing loss module 146 is configured to increase the value of the unit test passing loss, or otherwise set the value of the unit test passing loss to indicate that a unit test has failed. In one embodiment, unit test passing loss module 146 may be executed multiple times for multiple test cases, and an average value of unit test passing loss determined for the multiple test cases.

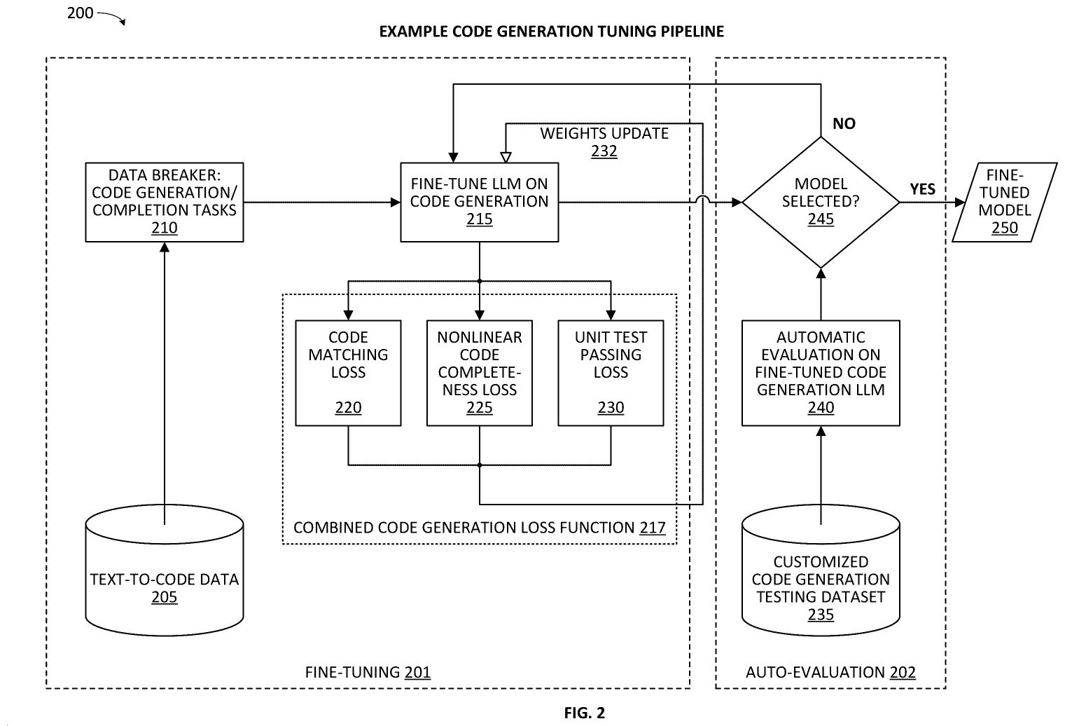

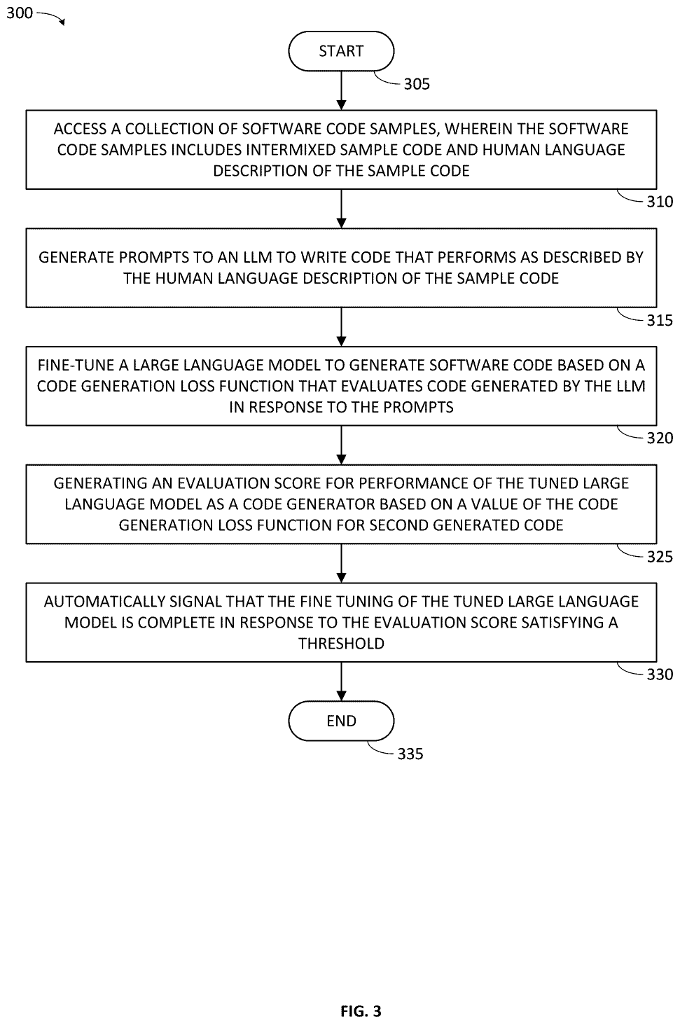

The foregoing component loss analyses are described in further detail below, for example with reference to combined code generation loss analysis 217 of FIG. 2, and blocks 320 and 325 of FIG. 3. In one embodiment, code generation loss module 136 may include as components various other loss analyses (not shown) that are associated with assessing the quality of the generated code. For example, code generation loss module 136 could also include: (1) a syntax correctness loss that is configured to determine whether and/or to quantify an extent to which the generated code 138 adheres to the syntax rules of the target programming language; (2) a Levenshtein distance loss that is configured to determine a number of single-character edits required to change the generated code 138 into the sample code 124; (3) a BLEU (Bilingual Evaluation Understudy) score loss that is configured to quantify similarity between the generated code 138 and sample code 124 based on n-gram overlap; (4) an execution speed loss that is configured to compare the time it takes for the generated code 138 and sample code 124, respectively, to execute and complete one or more test cases; (5) a resource utilization loss that is configured to compare the memory and processor usage by the generated code 138 and sample code 124, respectively, to execute and complete one or more test cases; (6) an algorithmic efficiency loss that is configured to compare time complexity and/or space complexity of the generated code 138 and sample code 124; (7) an error handling loss that that is configured to determine whether and/or to quantify an extent to which the generated code 138 includes error handling mechanisms for unexpected inputs or situations; and (8) a vulnerability loss that penalizes the inclusion of known security vulnerabilities (such as vulnerability to SQL injection, buffer overflows, or other attacks) in the generated code 138. In one embodiment, the values of all component loss functions of code generation loss module 136 may be normalized to a range, such as between 0 and 1 before combination in code generation loss module 136.

In one embodiment, automatic LLM evaluator 110 is configured to generate an evaluation score 150 for performance of the tuned large language model as a code generator. Evaluation score 150 (or other metrics) characterizes or quantifies the performance of tuned LLM 134. For example, automatic LLM evaluator 110 may be configured to generate evaluation score 150 based on a reference code sample 120 from testing database 114. More particularly, automatic LLM evaluator 110 is configured to generate evaluation score 150 based on additional generated code 152. The additional generated code 152 is generated by the tuned LLM 132 from a reference prompt 130 extracted by reference parser 107 from reference code sample 120. The additional generated code 152 is generated to be a specimen that demonstrates the behavior of the tuned LLM 132 following fine-tuning beyond the baseline of the initial LLM 130.

Automatic LLM evaluator 110 is configured to execute unit test passing loss 146 of code generation loss module 136 to obtain one or more unit test passing loss values for the additional generated code 152. In one embodiment, automatic LLM evaluator 110 is configured to provide reference code 128, and additional generated code 152, and test case(s) 131 as inputs to code generation loss module 136. And, automatic LLM evaluator 110 is configured to execute unit test passing loss 146 on these inputs to produce unit test passing loss values for one or more (or each) of the test cases 131. For example, for each of the test case(s) 131, automatic LLM evaluator 110 is configured to execute unit test passing loss module 146 to quantify failure of the additional generated code 152 as a whole to produce expected output of the reference code 128 as a whole, in a manner similar to that described above with reference to sample code 124 and generated code 138.

In one embodiment, automatic LLM evaluator 110 is configured to generate the evaluation score 150 based on the values of unit test passing loss between reference code 128 and additional generated code 152 for the test cases 131. For example, automatic LLM evaluator 110 may be configured to assign the evaluation score 150 to be the ratio of successful unit tests to the count of test cases 131. In other words, the evaluation score 150 may be quotient of the number the test cases 131 where the unit test is passed (unit test passing loss value is 0) to the total number of the test cases 131 evaluated for unit test passing loss between reference code 128 and additional generated code 152. In one embodiment, automatic LLM evaluator 110 is configured to provide evaluation score 150 to deployment decider 112 for evaluation against a threshold 154.

In one embodiment, deployment decider 112 is configured to automatically determine to deploy 158 the tuned large language model 134 to a production environment 156 for code generation in response to the evaluation score satisfying the threshold 154. Where the value of evaluation score 150 satisfies the threshold 154—that is, the condition(s) of threshold 154 evaluate to “TRUE” given the value of evaluation score 150—deployment decider 112 is configured to automatically deploy 158 tuned large language model 134 to perform code generation tasks in a production environment 156. Where the value of evaluation score 150 does not satisfy the threshold 154—that is, the condition(s) of threshold 154 evaluate to “FALSE” given the value of evaluation score 150—deployment decider 112 is configured to not deploy tuned large language model 134 to perform the code generation tasks in the production environment. Instead, deployment decider 112 is configured to initiate a further epoch of training to further improve the code generation ability of tuned LLM 132.

In one embodiment, where higher values of the evaluation score 150 (e.g., a higher ratio of successful unit tests) represent better performance of an LLM at code generation, threshold 154 is a minimum value that is satisfied when exceeded by the evaluation score. (In another, alternative embodiment, where lower values of the evaluation score represent better performance of an LLM at code generation—for example, where unit test passing loss itself is used as the evaluation score—threshold 154 is a maximum value that is satisfied when evaluation score 150 falls short of the maximum value.) Additional conditions may also be included in threshold 154.

In one embodiment, deployment decider 112 is configured to automatically determine whether to deploy 158 the tuned large language model 134 to perform code generation tasks in response to the evaluation score 150 satisfying a threshold 154. In one embodiment, where a relatively lower evaluation score 150 indicates better performance than a relatively higher evaluation score 150, the threshold 154 may be set at a previous maximum (highest or best) evaluation score 150 previously achieved by the LLM before fine-tuning. The threshold 154 is satisfied where an evaluation score higher than the previous maximum evaluation score is achieved. This indicates an improvement in code generation ability (as assessed by unit test passing loss 146) over a previous best. Thus, deployment decider 112 is configured to deploy 158 tuned LLM 134 to the production environment 156 to perform code generation tasks when the tuned LLM 134 has improved. In this manner, deployment decider 112 is configured to determine whether the tuned LLM 134 is sufficiently fine-tuned for deployment.

In one embodiment, where threshold 154 is satisfied, deployment decider 112 is configured to automatically generate a signal that is determinative as to whether to deploy 158 the tuned LLM 134 to production environment 156, or to initiate further rounds of training for the tuned LLM 134. For instance, deployment decider 112 is configured to automatically generate a trigger signal that indicates that fine tuning of the tuned LLM 134 is complete or otherwise satisfactory. And, where threshold 154 is not satisfied, deployment decider 112 may automatically generate a retune signal that indicates that fine tuning of the tuned LLM 134 is not yet complete or is otherwise unsatisfactory. Further training of the tuned LLM 134 may be initiated in response to receipt of the retune signal.

In one embodiment, deployment decider 112 is configured to initiate automated deployment of the tuned LLM 134 to a production environment in response to receipt of the trigger signal. In one embodiment, deployment decider 112 is configured to automatically deploy 158 the tuned LLM 134 by accepting or selecting the tuned LLM 134 for promotion to operation in the live or production environment 156. And, in one embodiment, deployment decider 112 is further configured to automatically carry out the promotion of the tuned LLM 134 to the production environment 156. For example, the deployment decider 112 is configured to integrate the tuned LLM 134 into the production environment 156 by automatically updating the model serving infrastructure, application programming interfaces (APIs), and/or other components used for operating the LLM to generate software code.

The automated deployment process rolls the tuned LLM 134 out to production environment 156 to replace or supersede a prior code generation LLM. As examples, the prior LLM may be an earlier training iteration or version of tuned LLM 134 (for example, LLM 132), or an alternative LLM configured for code generation that has a training history that differs from or is discrete from that of tuned LLM 134 or LLM 132. In one embodiment, deployment decider 112 is configured to automatically execute steps to replace the prior LLM in the production environment 156 with the tuned LLM 134. In one embodiment, the steps for automated deployment are performed by another component or module of code generation tuning system 100 in response to direction by the deployment decider 112 (for example, in response to the trigger signal). The automated deployment of the tuned LLM 134 minimizes disruption to the production environment 156 while incorporating the improved code generation ability of tuned LLM 134. In one embodiment, deployment decider 112 is configured to automate deployment of the tuned LLM 134 by a process of administrator confirmation (optional), model serialization, and API integration.

As an optional initial step, an administrator is presented with a choice to confirm or reject the automated deployment of tuned LLM 134 into the production environment 156. For example, the choice may be presented as a user-selectable option (such as a button) in a graphical user interface to code generation tuning system 100.

In one embodiment, deployment decider 112 then proceeds to serialize the tuned LLM 134. Prior to serialization, tuned LLM 134 is represented as an object, such as a Python object. Deployment decider 112 encapsulates the architecture, learned weights for improved code generation performance, and other parameters of the tuned LLM 134 into a serialized format for storage as a data structure. For example, deployment decider 112 accesses and executes a serialization function (such as ‘dump( )’ in the ‘joblib’ library for the scikit-learn ecosystem) on the tuned LLM 134. Similar serialization functions are available in other machine learning ecosystems. The serialized, tuned LLM 134 may be loaded into memory or otherwise accessed from the serialized data structure. The serialized, tuned LLM 134 is written to a specified storage location accessible by the production environment 156.

In one embodiment, deployment decider 112 then integrates the serialized, tuned LLM 134 into an existing API infrastructure for the production environment 156. Deployment decider updates the existing API endpoints and functionality to accommodate the tuned LLM 134. In one embodiment, discrete endpoints are defined to support various natural language processing tasks or functionalities. In one embodiment, there is a software code generation endpoint dedicated to code generation tasks. The software code generation endpoint accepts parameters such as prompts for generation of software code, and target languages for the software code to be generated in. For example, the endpoint path may be ‘/generate_code’.

Deployment decider 112 updates code for the software code generation endpoint in the production environment 156. The updates change the code for the software code generation endpoint to load the serialized, tuned LLM 134, rather than the serialized prior LLM. For example, the code for the software code generation endpoint is modified to (i) initialize the serialized, tuned LLM 134 (rather than initializing the prior LLM) from the specified storage location, and (2) direct incoming software code generation requests to be handled by the initialized, tuned LLM 134 (rather than directing tasks to the prior LLM). Access to the prior LLM through the software code generation endpoint is discontinued by removal of code to initialize or direct requests to the prior LLM, and the serialized prior LLM may be removed from the production environment 156. In one embodiment, the changes to the code of the software code generation endpoint are managed by a version control system to allow for consistent deployment to the production environment, and allow for roll-back of the changes. In this way, the tuned LLM 134 that has been fine tuned to improve software code generation may be automatically rolled out to the production environment 156.

Further details regarding code generation tuning system 100 are presented herein. In one embodiment, the operation of code generation tuning system 100 to fine tune the LLM for a code generation task will be described with reference to code generation tuning pipeline 200 shown in FIG. 2 and example code generation tuning method 300 shown in FIG. 3.

### —LLM Fine-Tuning for Code Generation—

As discussed above, an LLM may be configured to generate software code. Given a natural language description for some certain requirements/context, an LLM-based code generator generates source code in a programming language from a higher-level representation or specification.

In one embodiment, a code generation tuning system (such as code generation tuning system 100) implements a process or pipeline to fine-tune an LLM for the code generation task. The code generation tuning system 100 is configured to automatically improve code generated by the LLM-based code generator. In order to improve the code generation ability of the LLM, customized code generation data and a code generation loss function that are specific to code generation are used to further fine tune the LLM on a variety of programming languages.

From a natural language description of software functionality, the LLM can generate programming language to implement the functionality. An example of text-to-code data (including a natural language description and corresponding software code implementation) is shown in Table 1 below:

TABLE 1

| Example Description | Example Input/Output |
|---|---|
| Text-Code (text-to-code | Input: |
| generation) | “Write a python function which sorts a list of |
| | number from small to large” |
| | Expected output: |
| | def sort_numbers(numbers): |
| | sorted_numbers = sorted(numbers) |
| | return sorted_numbers |

Because prompts specifying code functionality may be derived from in-line, natural language comments to the software code, the code generation tuning system 100 is not dependent on purpose-written prompts in order to improve LLM performance as a software code generator.

In one embodiment, at a high level, the code generation tuning system implements a pipeline to fine-tune an LLM for the code generation task. A pre-trained LLM may have a basic code generation ability, however, the LLM may still have a lot of room to improve for certain tasks and certain programming languages. The code generation tuning system first collects customized code generation data designed for multiple different programming languages (such as included in training database 102). When targeting a specific programming language, the code generation tuning system fine-tunes the LLM on that programming language to optimize the code generation performance. A specifically designed unit testing dataset (such as is included in testing database 114) is then used to measure the pass rate for the code generation ability of the LLM.

FIG. 2 illustrates an example code generation tuning pipeline 200 associated with fine-tuning an LLM-based code generator. FIG. 2 provides a general overview of fine-tuning of LLM code generation. In one embodiment, there are two general parts in code generation tuning pipeline 200: fine-tuning 201 and auto-evaluation 202. In one embodiment, code generation data (such as text-to-code data 205) specifically targets text-code pairs in different natural language/code pair combinations. The code generation data is used to fine-tune code generation ability of the LLM with a training process. The fine-tuning 201 uses a novel loss function design (described in further elsewhere herein) that includes unit test passing loss. The fine-tuned model is then processed by an automatic evaluation 202 pipeline that is specifically configured for evaluating LLM code generation. If the model satisfies selection metrics, the fine-tuned model will be selected to output. If not, the pipeline will trace back to the fine-tuning stage and keep fine-tuning the LLM on the code generation task to get a more fine-tuned (better) LLM model.

In one embodiment, the fine-tuning 201 part of code generation tuning pipeline 200 includes text-to-code data 205, data breaker 210, fine-tuning for code generation 215, code matching loss function 220, nonlinear code completeness loss function 225, and unit test passing loss function 230. And, the auto-evaluation 202 part of code generation tuning pipeline 200 includes code generation testing dataset 235, automatic evaluation for code generation 240, and model selection for code generation 245. In one embodiment, code generation tuning pipeline 200 produces a fine-tuned model for code generation 250 as output.

In one embodiment, text-to-code data 205 is a database (such as training database 102) or other collection that includes a plurality of commented code samples 116—data structures such as files that include human-written software code along with human language description of the code. In one embodiment, the code samples are of software code accompanied by accurate English language descriptions of the functionality of the code. For example, the human language description of the software code may be comments in the body of the software code that describe the functionality. Or, for example, the human language description may be a statement in the code document specifying the functionality of the human-written software code. Note that the human produced software code and the human language description of the operation and functionality of the software code may be integrated in a single document. Further, the human language description may be intermixed or mingled with the code in the form of comments to the code.

In one embodiment, data breaker 210 preprocesses the text-to-code data 205 to separate the code description and the software code. For example, the contents of a code sample may be parsed to identify human-written comments to the software code as descriptions of the code, and to identify non-comment text content of the software code sample to be the human-written software code. In one embodiment, the data breaker 210 converts the descriptions of the code to completion instructions. In one embodiment, the completion instructions are a human language prompt to create the human written software code. In other words, data breaker 210 extracts descriptions of the human written software from the code sample and formats them into the style of a prompt for an LLM. In one embodiment, in addition to separating code language and human language description of the code, data breaker 210 also extracts a programming language from the code sample.

In one embodiment, data breaker 210 populates a template prompt with the programming language and description, such as “Write a [insert programming language here] function to [insert description(s) here].” Accordingly, the data breaker 210 generates a prompt as an input for the LLM, and the expected output is the human-written software code. The human-written software code may be used as the ground truth, expected output of the LLM in response to the prompt. In one embodiment, the pre-processing by data breaker 210 repeats for each member of a plurality of code samples 116 in a batch of code samples retrieved from training database 102. Additional detail regarding the generation of prompts is described with reference to block 315 of code generation tuning method 300 and data breaker 106 of FIG. 1. In one embodiment, the functions of data breaker 210 are performed by data breaker 106.

In one embodiment, fine tuning for code generation 215 is configured to execute a training process based on a novel combined code generation loss function 217 (discussed in further detail below). In one embodiment, the functions of fine tuning for code generation 215 are performed by LLM fine tuner 108. In one embodiment, fine tuning for code generation 215 loads of batch of text-to-code data 205 and performs an iterative training process for LLM using the plurality of pre-processed code samples—that is, code samples that were separated into sample code and prompts as discussed for data breaker 106 and 205—in the batch. At a high level, fine tuning for code generation 215 repeats a training process of LLM output prediction (that is, generation of code), combined code generation loss function 217 analysis, and weights updates 232 for the plurality of pre-processed code samples in the batch. This process may be referred to as a training epoch for fine tuning the code generation capabilities of the LLM. A batch or epoch may consist of several thousand code samples. At a high level, code generation tuning system 100 repeats the data breaking, and training of the LLM for the plurality of code samples in the batch.

In one embodiment, fine tuning for code generation 215 trains the LLM 132 to better mimic human software code writing by training the LLM with one or more epochs of code samples 116. During the training, Fine-tuning for code generation 215 operates to update the weights of the LLM based on the combined loss value. For example, fine-tuning for code generation 215 adjusts weights of the LLM 132 iteratively to optimize (e.g., minimize) the combined code generation loss function 217. In one embodiment, the weights of LLM 132 are adjusted by iterative backpropagation (propagating gradient of the code generation loss function 217 with respect to the individual weights of the output layer of the LLM 132 backward through the layers of the LLM 132) and gradient descent (adjusting the individual weights in the opposite direction of their respective gradients (as assigned by the backpropagation) by a pre-set “learning rate” hyperparameter). In other embodiments, the weights of LLM 132 may be adjusted by other training algorithms, such as by reinforcement learning.

At the conclusion of a training epoch, the trained LLM 134 will be evaluated for improvement in code generation performance. For example, upon completion of an epoch of training, code generation tuning system 100 proceeds to an auto evaluation phase 202 and determines whether or not to select the tuned model 134 for output as a fine-tuned LLM 250, as discussed below with respect to model selection for code generation 245.

In one embodiment, combined code generation loss function 217 is made-up of code matching loss function 220, nonlinear code completeness loss function 225 and unit test passing loss function 230. The component loss functions 220 through 230 of the combined loss function quantify various ways in which software code generated by the LLM differs from the ground truth software code extracted by data breaker 210. In one embodiment, the code matching loss function 220, the nonlinear code completeness loss function 225 and the unit test passing loss function 230 are averaged to produce a combined loss value for LLM code generation. The last value is returned to the fine tuning for code generation 215.

In one embodiment, the functions of combined code generation loss function 217 are implemented by code generation loss module 136. In particular, code matching loss function 220 is implemented by code matching loss module 142, nonlinear code completeness loss function 225 is implemented by non-linear code completeness loss module 144, and unit test passing loss function 230 is implemented by unit test passing loss module 146.

In one embodiment, code matching loss function 220 is configured to check the matching between output code (e.g., generated code 138) from LLM and ground truth code (e.g., sample code 124) semantically. In other words, code matching loss function 220 determines an extent of dissimilarity between code generated from a description, and original code that the description is describing. Therefore, in one embodiment, code matching loss function 220 measures the recall and precision at a token (e.g., word, variable, operator, etc.) level. Here, recall refers to an extent to which individual tokens in the sample code also occur in any order in the generated code. And, here, precision refers to an extent to which tokens in the sample code occur in a same order as in the sample code. Higher recall/precision means less loss, and vice versa. In one embodiment, the scores for recall and precision may be normalized to the interval of zero to 1. In one embodiment, the scores for recall and precision may be weighted to emphasize or deemphasize one score or another in the overall code matching loss. In one embodiment, the recall and precision scores may be averaged to produce an overall code matching loss. Thus, in one embodiment, code matching loss function 220 operates to penalize dissimilarity of generated code with sample code, for example by generating a value of code matching loss that indicates an extent of dissimilarity between the sample code and the generated code.

In one embodiment, nonlinear code completeness loss function 225 is configured to measure the whether the generated software code is able to produce expected output on a line-by-line basis. In other words, non-linear code completeness loss function 225 detects where the generated code introduces errors that prevent correct results of the function. In one embodiment, non-linear completeness loss function 225 compares results of executing a line of code in the generated code with results of executing a corresponding line of code in the ground truth code extracted by data breaker 210. For example, given 10 lines of generated code, when the input starts from the 1st line, each line should have an expected output that matches with output for a corresponding line of ground truth code. If the output at a generated line does not match the output for a similarly positioned line in the ground truth, then code generation tuning pipeline 200 adds some loss for this generated line.

Non-linear means the weights of each line is not the same, since if wrong output occurs at the very beginning of the code, then the following lines are also producing wrong output. Therefore, the weight for loss at the beginning is higher than the weight for loss at the last lines. In other words, mistakes earlier in the generated code are weighted more heavily than later mistakes in the generated code. The values of the weights applied to the lines of code may be determined experimentally. In one embodiment, the weight applied for an error in an initial line of generated code may be set at a convenient arbitrary value such as 1024, and the value of the weight halved for each subsequent line beyond the initial, such that the second line will weight its errors by 512, the third by 256, and so on. Other line-by-line weighting functions may also be appropriate. To determine the non-linear code completeness loss for generated code, the weights assigned to each line where the generated code does not produce output consistent with a corresponding line of the ground truth code are cumulatively summed. Thus, in one embodiment, nonlinear code completeness loss function 225 operates to penalize incompleteness of the generated code 138, for example, by generating a value of non-linear code completeness loss that indicates an extent to which the generated code 138 fails to produce expected output (e.g., sample code 124) on a line-by-line basis.

In one embodiment, unit test passing loss function 230 tests to determine whether the generated code 138 correctly performs the function of the sample code 124. In other words, unit test passing loss function 230 checks if the final output of the generated code 138 is correct for a given test case by comparing the final output of the generated code 138 to the final output of the sample code 124 to see if the output match. In one embodiment, each code generation data sample in the text-to-code data has multiple unit test cases. In one embodiment, the test cases can be automatically generated and then performed by the ground truth and generated code. The results of executing a unit test case with the generated code may be checked against executing the same unit test case with the ground truth code (e.g., sample code 124) extracted by data breaker 210. If the results of the unit test case match for the generated and ground code, the unit test is passed. If all the unit tests are passed, then this unit test passing loss is zero. Otherwise, there will be loss penalty for not passing some unit tests. In one embodiment, the loss penalty is the ratio of unit tests passed to total unit test cases.

For example, where the function is to sort numbers in an ascending order, a unit test case of numbers, e.g., 10, 5, 3, 4, may be included in text-to-code 205 in association with the particular software code sample. The ground truth code will correctly sort these numbers to 3, 4, 5, 10. Where the generated code also sorts the numbers to 3, 4, 5, 10, the unit test is passed. Where the generated code produces some other order of the numbers, the unit test is failed. Thus, in one embodiment, unit test passing loss function 230 operates to penalize inoperability of the generated code 138, for example, by generating a value of unit test passing loss that indicates an extent to which the generated code 138 fails to produce output that is consistent with the output of the sample code 124.

In one embodiment, testing dataset for code generation 235 is a database (such as testing database 114) or other collection of reference code samples 120—data structures such as files that include human written software code along with human language descriptions of functionality of the code, similar to that of text-to-code data 205. The code samples in testing data set for code generation 235 are discrete from and do not overlap the code samples in text-to-code data 205, thereby preventing overfitting. In one embodiment, testing data set for code generation 235 includes a few hundred to a few thousand code samples.

In one embodiment, testing data set for code generation 235 is a golden or benchmarking dataset. The testing dataset for code generation 235 is used as a reference for testing for code generation performance. In one embodiment, the testing dataset may be formatted as pairs of reference prompts 130 and reference code 128, such as is shown above with reference to Table 1. In one embodiment, the testing dataset for code generation 235 includes a reference prompt 130 that has been prepared by a human, and reference code 128 that has been prepared by a human as an acceptable or desired response to the reference prompt. In one embodiment, the testing dataset for code generation 235 further includes one or more test cases 131 for evaluating whether code generated by tuned LLM in response to reference prompt passes a unit test. In short, the “golden” data of the testing dataset for code generation 235 provides a reference, benchmark, or other standard demonstrating an expected quality level for generated software code.

Following the fine-tuning phase 201, example code generation tuning pipeline 200 proceeds to the auto-evaluation phase 202. During the auto-evaluation phase 202, code generation tuning system accesses testing data for code generation 235 to retrieve code samples, executes the tuned LLM 134 to produce responses to the inputs or prompts in the conversations, and then evaluates how well the tuned LLM 134 performs in the code generation use case.

In one embodiment, automatic evaluation for code generation 240 quantifies how well the tuned LLM 134 performs as a code generation tool following training. The quantification is based on comparisons between generated code (e.g., additional generated code 152) and ground truth code (e.g., reference code 128) for a given human language description (e.g., reference prompt 130) of code functionality. In one embodiment, the functions of automatic evaluation for code generation 240 are performed by automatic LLM evaluator 110. In one embodiment, code generation tuning system 100 evaluates similarity between the final outputs or results of generated and ground truth software code. In one embodiment, automatic evaluation for code generation 240 performs a unit test evaluation based on testing data set for code generation 235. Testing data set for code generation 235 includes human language descriptions of code functionality (e.g., reference prompt 130), ground truth code that implements the described functionality (e.g., reference code 128), and, in one embodiment, one or more unit test cases (e.g., test cases 131) for verifying that code subjected to the unit test performs the described functionality. In one embodiment, an evaluation score or metric (e.g., evaluation score 150) is generated to quantify how well the tuned LLM 134 performs as a code generator. The evaluation score is based on whether the generated code passes the unit test or not. In one embodiment, the evaluation score is the ratio of unit tests passed to total unit tests for a given code sample in testing data set for code generation 235.

In one embodiment, model selection for code generation 245 determines whether the tuned LLM is sufficiently improved over its prior peak ability to generate software code to warrant promotion to a fine-tuned model for code generation 250 as output, or not. If not, then code generation tuning pipeline 200 returns to fine tuning for code generation 215 for an additional training epoch using a further batch of code samples from text-to-code data 205, as processed by data breaker 210. In one embodiment, the threshold 154 for selecting an LLM to be a fine-tuned model for code generation 250 as output is whether the evaluation score 150 (as discussed above, a score or metric based on a unit test passing analysis) produced by automatic evaluation for code generation 240 exceeds a previous high score for the unit test case. In one embodiment, the threshold 154 for selecting an LLM to be a fine-tuned model for code generation 250 is whether the evaluation score 150 exceeds the previous high score by at least a pre-set ratio, such as an improvement of 1% or more. Where the threshold 154 is satisfied by the evaluation score 150, the tuned model is selected (245: YES) for promotion to a production environment. Where the threshold 154 is not satisfied by the evaluation score 150, the tuned model is not selected (245: NO) for promotion to a production environment, and the code generation tuning pipeline 200 returns to block 215 for another epoch of training with further code samples 116 from text-to-code data 205.

### —Example Code Generation Tuning Method—

FIG. 3 illustrates one embodiment of a code generation tuning method 300 associated with automated LLM fine-tuning for code generation. In one embodiment, code generation tuning method 300 is a technique to fine-tune an LLM in order to improve an ability of the LLM to generate software code based on a prompt using a collection of commented software code samples. In one embodiment, code generation tuning method 300 may implement an automatic evaluation pipeline that analyzes the code generation ability of an LLM that has been fine-tuned, such as code generation tuning pipeline 200 shown and described above with reference to FIG. 2. The analysis is automatic, and based on an evaluation score derived from an automated unit test analysis (such as is performed in unit test passing loss module 146 and unit test passing loss 230), thereby fully automating evaluation of code generation output.

In one embodiment, to fine-tune LLM weights of LLM 132 for optimized software code generation ability, code generation tuning method 300 uses a custom set of training data, such as the collections of code samples 116 and reference code samples 120 held in training database 102 and testing database 114, respectively. The custom training data is curated for improving the performance of software generation. Code generation tuning method 300 implements an automated evaluation of software code generation that iteratively analyzes the improvement (or degradation) of the tuned LLM 134 over LLM 132 to obtain optimized (or more accurate) LLM weights for software code generation.

In one embodiment, as a general overview, code generation tuning method 300 accesses a collection of software code samples. The code samples include software code and human language comments that describe the functionality of the software code. Code generation tuning method 300 extracts the comments, and reformats the comments into the form of a prompt to the LLM that requests software code with the described functionality. Code generation tuning method 300 adjusts weights of the LLM in order to reduce a loss analysis of code generated in response to the prompt. Code generation tuning method 300 then scores how well the adjusted LLM performs as a code generator. Code generation tuning method 300 compares the score to a threshold to determine whether or not to signal that the LLM is satisfactorily fine-tuned. In one embodiment, once the threshold is satisfied, code generation tuning method 300 automatically decides to deploy the adjusted LLM to a production environment.

In one embodiment, code generation tuning method 300 initiates at START block 305 in response to an LLM tuning system determining that (i) an LLM has been submitted to the LLM tuning system to have its performance as a code generator fine-tuned; (ii) an instruction to perform the code generation tuning method 300 has been received by LLM tuning system; (iii) a retune signal has been received indicating that an LLM being fine-tuned has not yet satisfied a threshold for code generation performance; (iv) it is currently a time at which the code generation tuning method 300 is scheduled to be run; or (iv) that code generation tuning method 300 should commence in response to some other condition. In one embodiment, a computer system configured by computer-executable instructions to execute functions of code generation tuning system 100 and/or code generation tuning pipeline 200 executes the code generation tuning method 300. Following initiation at START block 305, code generation tuning method 300 continues to block 310.

At block 310, code generation tuning method 300 accesses a collection of software code samples. The software code samples includes intermixed sample code and human language description of the sample code. In other words, code generation tuning method 300 accesses the training database 102 of text-to code data 205 in which examples of software code include comments that describe code functionality.

In one embodiment, to access the collection of software code samples, code generation tuning method 300 (i) initializes a data handler component (such as data handler 104); (ii) establishes a connection to a training database (such as training database 102); (iii) retrieves a sufficient quantity of code samples (such as code samples 116) from the training database to be used for an epoch of training; and (iv) provides the code samples to a data breaker component (such as data breaker 106) for separation of sample code from comments and generation of prompts from the comments. In one embodiment, the quantity of code samples for the epoch of training are organized as a batch, for example by being placed into a data structure or array for subsequent processing. In this manner, the collection of code samples is accessed and the code samples are configured for subsequent operations to fine-tune the LLM.

In one embodiment, code generation tuning method 300 also accesses the customized code generation testing dataset 235 from testing database 114 in a manner similar to that described above for the code samples in the training database. In this way, code generation tuning method obtains reference code samples, and provides the reference code samples to a reference parser component (such as reference parser 107).

In one embodiment, the steps of block 310 are performed by data handler 104. At the conclusion of block 315, code generation tuning method 300 has accessed and retrieved code samples 116 for fine-tuning the LLM. Processing continues to block 315.

At block 315, code generation tuning method 300 generates prompts to an LLM to write code that performs as described by the human language description of the sample code. In one embodiment, at a high level, the code generation tuning method 300 generates the prompts by extracting comments from the sample code and populating a template prompt with the comments. For example, code generation tuning method 300 parses the software code samples to detect comment markers that separate the sample code from the human language comments that describe the functionality of the sample code. Then, code generation tuning method 300 reformats human language comments denoted by the comment markers into a prompt to an LLM.

In one embodiment, to generate a prompt, code generation tuning method 300 (i) initializes a data breaker component (such as data breaker 106); (ii) retrieves or otherwise accesses a code sample from a batch of code samples (such as code samples 116 compiled by data handler 104); (iii) parses the intermixed code and description of the code sample to separate human language comments from the sample code based on comment markers; (iv) identifies a programming language of the sample code to be a designated or target language for generated software code; (v) populate a template prompt with the programming language and the human language comments to generate the prompt; and (vi) transmits the generated prompt to an LLM fine-tuner component (such as LLM fine tuner 108) for use in fine tuning the LLM. In one embodiment, code generation tuning method 300 performs these steps for more than one (or each) each software code sample in a batch or epoch of code samples. In one embodiment, code generation tuning method 300 automatically identifies the language of the software code sample prior to parsing the code so as to determine the format of comment markers.

In one embodiment, the code generation method 300 may automatically detect the coding language (or programming language) of the sample code from the intermixed code and description. In one embodiment, to identify the language of the sample code, code generation tuning method accesses a database (or other data structure) that maps features (e.g., keywords, file extensions, syntax structures, and names of libraries or functions) that are uniquely indicative of various programming languages to the respective programming languages. Then, the code generation tuning method 300 scans the intermixed code and description to identify the features that are present in the sample code. Code generation tuning method 300 then assigns a score to each possible programming language based on the presence of its identifying features, and selects, as the language of the sample code, the programming language with the highest score.

Or, in one embodiment, the code sample may include a label indicating the programming language of the sample code, which may be read by the code generation tuning method 300 to identify the language of the sample code. In either case, the detected coding language may be included in the prompt.

In one embodiment, code generation tuning method 300 examines the intermixed code and description to separate the sample code from the human language description. For example, code generation tuning method 300 initializes two empty lists or other data structures, one for storing the sample code, and one for storing the human language description. The code generation tuning method 300 accesses a database (or other data structure) that indicates the formats for comments used in the programming language. For example, the start of single line comments may be denoted by the marker // in C++ and Java, or by #in Python, and the start and end of multi-line comments may be denoted by the markers /* . . . */ in C++ and Java, or by “ . . . ” in Python.

For each line of the intermixed code and description, the line is checked for single line comments and multi-line comments. In one embodiment, code generation method 300 checks for the comment markers for the detected coding language. In another embodiment, code-generation method checks for the comment markers of more than one language. In one embodiment, the checking is carried out by examining the lines of intermixed code and description with regular expressions configured to detect the comment markers.

If the line contains a start marker for a single line comment, the portion of the line before the marker is added to the list for sample code, and the portion of the line following the marker is added to the list for human language description. If the line contains a start marker for a multi-line comment, the portion of the line before the marker is added to the list for sample code, the portion of the line following the marker is added to the list for human language description, and the content of the lines following the marker are added to the list for human language description until an end marker for multi-line comments is encountered. If the line contains no comment markers, the entire line is added to the list for sample code.

Code generation tuning method 300 then combines the populated list for the sample code into a single string, file, or other text data structure that represents the sample code without comments. And, code generation tuning method 300 combines the populated list for the human language description into a single string, file, or other text data structure that represents the human language description (comments) without the sample code.

Once the human language description and sample code are thus separated, code generation tuning method 300 generates a prompt from the human language description. First, code generation tuning method 300 retrieves or otherwise accesses a template for creation of prompts. In one embodiment, the template defines a consistent structure for prompts. The template incorporates placeholders for the programming language and the human language description. For example, the template may include a prompt statement such as “Write a [insert programming language here] function to [insert description(s) here].” Code generation tuning method 300 then populates the template by filling in or otherwise replacing the placeholders in the template for programming language and description with the actual values extracted from the code sample. Once the template prompt is populated, code generation tuning method 300 stores the generated prompt. In one embodiment, the generated prompt is stored in a data structure that associates the prompt with its respective sample code and identified programming language.

In one embodiment, code generation tuning method 300 further specifically identifies designated inputs and outputs in the human language description, for example during the parsing. The template may further provide for description of these inputs and outputs. For example, the template may further include a statement such as “The function should accept [insert inputs here] as input and return [insert outputs here] as output.”

In one embodiment, the steps of block 315 are performed by data breaker 106. At the conclusion of block 315, code generation tuning method 300 has identified and separated sample code 124 and human language comments from intermixed code and description 118, and has generated prompt 126 from the human language comments. Processing continues to block 320.

At block 320, code generation tuning method 300 fine-tunes a large language model to generate software code. The fine-tuning is based on a code generation loss function. The code generation loss function evaluates code generated by the LLM in response to the prompts. Code generation tuning method 300 determines a value of code generation loss by analyzing the relationship between generated code created by the LLM in response to the prompts, and sample code originally described by the human language comments used to create the prompts in various ways. Code generation tuning method 300 then generates and applies adjustments (e.g., adjustments 140) to the weights of the LLM to improve the code generation loss.

In one embodiment, the value of code generation loss combines several distinct analyses. In one embodiment, code generation tuning method 300 evaluates how well the generated code matches the sample code, and increases a value of code matching loss based on the extent of mismatch. In one embodiment, code generation tuning method 300 evaluates how complete the generated code is with respect to the sample code, and increases a value of non-linear code completeness loss by amounts that are scaled by the priority or “earliness” of an error in the order of the generated code. In one embodiment, code generation tuning method iteratively evaluates whether or not the generated code produces the same results as the sample code for a variety of test cases, and increases a value of unit test passing loss based on a number of times the generated code fails to produce the same results as the sample code when both are executed on a given test case. These analyses may be combined, for example as a weighted average, to produce the code generation loss.

In one embodiment, code generation tuning method 300 initializes an LLM fine-tuner component (such as LLM fine tuner 108) to perform the steps of block 320. In one embodiment, to fine-tune the coding capabilities of a large language model, code generation tuning method 300 (i) accesses sample code 124 and prompt 126 extracted by data breaker 106; (ii) executes LLM 132 on the prompt 126 to produce generated code 138; (iii) submits generated code 138 and sample code 124 to code generation loss module 136 and executes combined code generation loss function 217 to produce a value of code generation loss; (iv) determine adjustments to weights of the LLM 132, for example by backpropagation of the gradient of the loss function through layers of the LLM 132; (v) apply the adjustments to the weights of the LLM 132 to generate the tuned LLM 134. In one embodiment, the fine-tuning process is repeated for a plurality of pairs of sample code 124 and associated prompt 126, for example through an epoch of fine-tuning.

In one embodiment, the steps of block 320 are performed by LLM fine-tuner 108 and associated components such as code generation loss module 136 and large language model 132. At the conclusion of block 315, code generation tuning method 300 has taken one or more pairs of sample code and associated prompts, and used them to improve the performance of a large language model at the task of code generation. Processing continues to block 325.

At block 325, code generation tuning method 300 generates an evaluation score (e.g., evaluation score 150) for performance of the tuned large language model (e.g., tuned LLM 134) as a software code generator based on a value of the code generation loss function (e.g., code generation loss function 217) for second generated code (e.g., additional generated code 152). In one embodiment, code generation tuning method 300 executes tuned LLM 134 on reference prompt 130 to generate additional generated code 152 for testing the tuned LLM 134. Then, code generation tuning method 300 executes unit test passing loss 146 on reference code 128 and additional generated code 152 for the test cases 131 to determine evaluation score 150.

In one embodiment, code generation tuning method 300 initializes an automatic LLM evaluator (such as automatic LLM evaluator 110) to perform the steps of block 325. In one embodiment, to generate the evaluation score 150, code generation tuning method (i) retrieves or otherwise accesses reference code 128, reference prompt 130, and test cases 131 extracted by reference parser 107; (ii) generates additional generated code 152 with the tuned LLM 134 for use in testing the code generation ability of tuned LLM 134; (iii) submits additional generated code 152, reference code 128, and test cases 131 to unit test passing loss module 146; (iv) iteratively executes unit test passing loss function 230 on additional generated code 152 and reference code 128 for each of the test cases 131 to determine whether or not the generated code 152 passes the unit test-producing “correct” output; (v) determine the evaluation score 150 by finding the ratio of passed unit tests to total test cases. The evaluation score 150 characterizes the capability of the LLM to generate functional software code from human language prompts. Code generation tuning method 300 then provides the evaluation score to a deployment decider (e.g., deployment decider 112) for determining whether the tuned LLM is ready for deployment to perform code generation tasks in a production environment, or should be given further round(s) of fine-tuning before deployment. For example, code generation tuning method 300 may transmit the evaluation score to the deployment decider.

In one embodiment, the steps of block 325 are performed by automatic LLM evaluator 110 and associated components such as unit test passing loss module 146, tuned LLM 134, and reference parser 107. At the conclusion of block 325, code generation tuning method 300 has produced an evaluation score that represents how much the adjustments have improved LLM performance at software generation. Processing continues to block 330.

At block 330, code generation tuning method 300 automatically signals that the fine tuning of the tuned large language model 134 is complete in response to the evaluation score 150 satisfying a threshold 154. In one embodiment, code generation tuning method 300 determines to deploy 158 the tuned large language model 134 to a production environment 156 for code generation in response to the evaluation score 150 satisfying a threshold 154. In one embodiment, code generation tuning method 300 initializes a deployment decider (such as deployment decider 112) to automatically determine whether to deploy 158 the tuned LLM 134 based on satisfying a threshold 154 for satisfactory code generation performance, or to repeat the fine-tuning process for further training epochs based on failure to satisfy the threshold 154.

In one embodiment, where the threshold 154 is not satisfied, code generation tuning method 300 signals that code generation tuning method 300 is to repeat for the tuned large language model 134, for example repeating beginning at block 310 above. Where the threshold 154 is satisfied, code generation tuning method 300 signals to initiate or cause automated deployment of the tuned large language model 134 to a production environment 156 for performance of code generation tasks. For example, code generation tuning method 300 automatically determines to deploy the tuned large language model 134 to a code generation task.

The deployment decider 112 defines a threshold (such as threshold 154) for the evaluation score 150 based on pre-determined performance criteria for the LLM, such as improvement over a previous “best” evaluation score for code generation achieved by the LLM under a prior iteration of tuning. The deployment decider 112 then populates conditions of the threshold 154 by inputting at least the value of the evaluation score 150. The deployment decider 112 evaluates the populated threshold to determine whether the threshold evaluates to a value (such as a Boolean “TRUE”) that indicates the threshold to be satisfied by the evaluation score, or to a value (such as a Boolean “FALSE”) that indicates the threshold to remain unsatisfied by the evaluation score.

If the evaluation of the threshold shows improvement over the previous best score for code generation performance by at least the threshold amount, the deployment decider automatically deploys the tuned LLM into the production environment 156 to perform code generation tasks. If the evaluation shows insufficient improvement in code generation performance, or even decrease in performance, the tuned LLM is not deployed. Instead, the deployment decider initiates further epochs of training with additional code samples for the tuned LLM, restarting code generation tuning method 300 at block 310 for the tuned LLM. In this way, improvements captured in the tuned LLM that were not sufficient to justify deployment are retained and further refined with additional training, and not discarded.

In one embodiment, once the deployment decider has determined to deploy the tuned LLM 134, deployment decider 112 automatically carries out the promotion of the LLM to the production environment, for example as described above with reference to deployment decider 112. In one embodiment, the determination to deploy the tuned LLM 134 may be presented in a user interface, such as a graphical user interface, for user or administrator confirmation or rejection of the deployment.

In one embodiment, a condition of satisfying the threshold is surpassing a previous best (for example, exceeding a previous maximum) for the evaluation score. In one embodiment, the threshold is defined by retrieving a pre-specified threshold for code generation performance from storage. In one embodiment, the threshold is defined by dynamically adjusting threshold conditions based on the previous “best” evaluation score—a prior peak ability of the LLM to generate software code. The previous “best” score may be, for example, a maximum score where higher evaluation scores indicate better code generation performance. The automatic LLM evaluator 110 may be configured to also store the previous best evaluation score that was previously achieved by a tuned LLM. In one embodiment, the previous best evaluation score may be set as a minimum to be exceeded in the threshold evaluation. In one embodiment, the value of the previous best evaluation score, plus a pre-determined margin of improvement, are set as the minimum to be exceeded in the threshold evaluation. Thus, in one embodiment, code generation tuning method 300 compares the evaluation score 150 to the previous best for the evaluation score.

At the conclusion of block 330, code generation tuning method 300 proceeds to END block 335, where code generation tuning method 300 terminates. At the conclusion of code generation tuning method 300, an LLM has been automatically fine-tuned for improved performance at generating software code, and (in one embodiment) automatically deployed to implement the improved code generation capabilities for code generation tasks going forward.

In one embodiment, a code generation tuning method accesses a collection of code samples, wherein the code samples include software code that is annotated with human language description of functionality of the software code. The code generation tuning method parses the code samples to extract the software code from the human language description. The code generation tuning method trains a large language model to approximate the software code based on a loss function that includes components for code matching loss, nonlinear code completeness loss, and unit tests passing loss between the extracted software code, and software code generated by the LLM. The code generation tuning method accesses a testing collection of code samples that includes second software code and second human language description of functionality of the second software code. The code generation tuning method generates an evaluation score for performance of the trained LLM as a code generator based on whether the LLM generates new code that passes a second unit test. Once the evaluation score exceeds a previous high, the code generation tuning method outputs the trained LLM as fine-tuned for use as a code generator.

### —Example Features of Code Generation Tuning Method—

In one embodiment, code generation tuning method 300 further includes generating the code generation loss function to penalize one or more of dissimilarity of generated code with the sample code, incompleteness of the generated code, and inoperability of the generated code.

In one embodiment, code generation tuning method 300 further includes generating, as a component of the code generation loss function (discussed at block 320), a value of code matching loss that indicates an extent of dissimilarity between the sample code and the generated code. In one embodiment, generation of the value of code matching loss includes generating a value of recall between the sample code and the generated code. Generation of the value of code matching loss also includes generating a value of precision between the sample code and the generated code. And, generation of the value of code matching loss includes combining the values of recall and precision to produce the value of code matching loss.

In one embodiment, code generation tuning method 300 further includes generating, as a component of the code generation loss function (discussed at block 320), a value of non-linear code completeness loss that indicates an extent to which the generated code fails to produce expected output on a line-by-line basis. In one embodiment, generation of the value of non-linear code completeness loss includes accessing a test case associated with the sample code. Generation of the value of non-linear code completeness loss includes recording line-by-line outputs of executing the sample code and the generated code on the test case. Generation of the value of non-linear code completeness loss includes comparing the outputs of corresponding individual lines of the sample code and the generated code. And, where the outputs differ for a corresponding individual line, generation of the value of non-linear code completeness loss includes adding to the value of non-linear code completeness loss an amount based on a line number of the corresponding individual line. For example, where the outputs differ for a corresponding individual line, code generation tuning method 300 assigns a loss amount based on a line number of the corresponding individual line and sums the assigned loss amounts for the individual lines to produce the value of non-linear code completeness loss.

In one embodiment, code generation tuning method 300 further includes generating, as a component of the code generation loss function (discussed at block 320), a value of unit test passing loss that indicates an extent to which the generated code fails to produce output consistent with the sample code. In one embodiment, generation of a value of unit test passing loss includes accessing a test case associated with the sample code. Generation of a value of unit test passing loss includes executing the sample code and the generated code on the test case. Generation of a value of unit test passing loss includes comparing results of the test case executed by the sample code and executed by the generated code. And, where the results differ, generation of a value of unit test passing loss includes increasing the value of the unit test passing loss.

In one embodiment, code generation tuning method 300 examines unit test passing loss for multiple test cases. Thus, in one embodiment, generation of a value of unit test passing loss includes accessing a set of test cases automatically generated for inputs to the sample code. Generation of a value of unit test passing loss then includes, for more than one of, or for each of the test cases in the set of test cases, (i) executing the sample code and the generated code on the test case, (ii) comparing results of the executing the sample code on the test case and the executing the generated code on the test case, and (iii) where the results differ, incrementing a tally of differing results. And, generation of a value of unit test passing loss includes determining a ratio of the tally of differing results to a count of the test cases to produce the value of unit test passing loss.

In one embodiment, generating prompts to an LLM to write codes that performs as described by the human language description of the sample code (as discussed at block 315) further includes (i) automatically detecting a coding language from the sample code, and (ii) including the detected coding language in the prompts.

In one embodiment, code generation tuning method 300 further includes accessing one or more test cases (such as test cases 131 provided with reference code samples 120, or automatically generated test cases). In one embodiment, code generation tuning method 300 further includes automatically generating one or more test cases based on inputs to the sample code. And, for example, code generation tuning method 300 further includes automatically generating one or more test cases based on Monte Carlo simulation of inputs to the sample code.

### Cloud or Enterprise Embodiments

In one embodiment, the present system (such as code generation system 100) is a computing/data processing system including a computing application or collection of distributed computing applications for access and use by other client computing devices that communicate with the present system over a network. In one embodiment, code generation system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, code generation system 100 is a centralized server-side application that provides at least the functions disclosed herein and that is accessed by many users by way of computing devices/terminals communicating with the computers of code generation system 100 (functioning as one or more servers) over a computer network. In one embodiment code generation system 100 may be implemented by a server or other computing device configured with hardware and software to implement the functions and features described herein.

In one embodiment, the components of code generation system 100 may be implemented as sets of one or more software modules executed by one or more computing devices specially configured for such execution. In one embodiment, the components of code generation system 100 are implemented on one or more hardware computing devices or hosts interconnected by a data network. For example, the components of code generation system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of code generation system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of code generation system 100 may (i) generate or compose an electronic message or signal to issue a command or request to another component, (ii) transmit the message or signal to other components of code generation system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by code generation system 100, for example through a web interface server. In one embodiment, the remote computing system may send requests to and receive responses from code generation system 100. In one example, access to the information or applications may be effected through use of a web browser on a personal computer or mobile device. In one example, communications exchanged with code generation system 100 may take the form of remote representational state transfer (REST) requests using JavaScript object notation (JSON) as the data interchange format for example, or simple object access protocol (SOAP) requests to and from XML servers. The REST or SOAP requests may include API calls to components of code generation system 100.

### Software Module Embodiments

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### Computing Device Embodiment

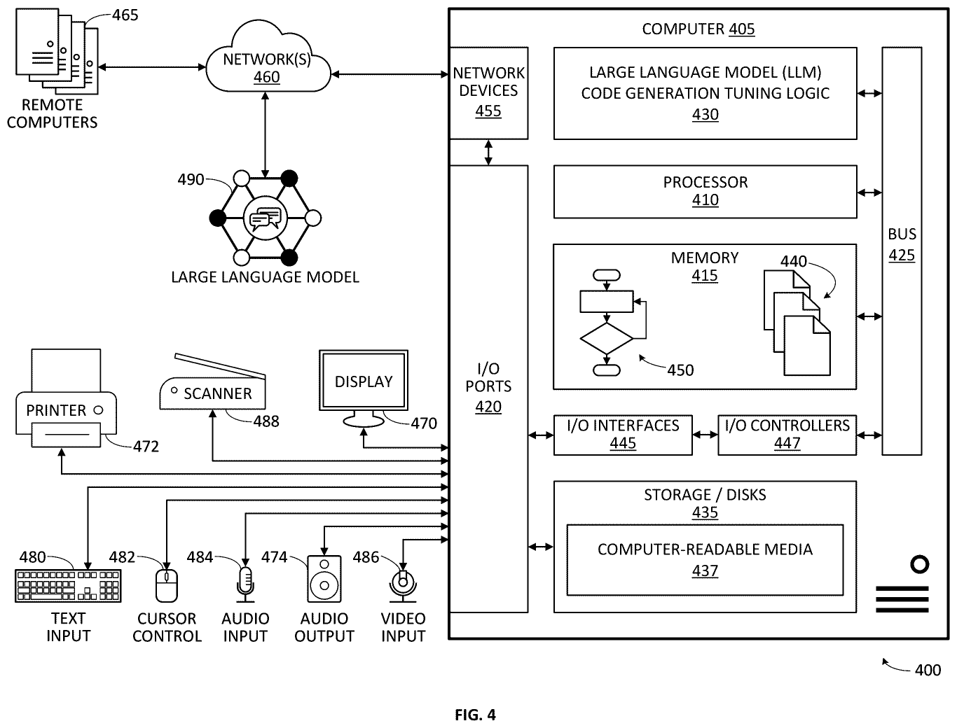

FIG. 4 illustrates an example computing system 400 that is configured and/or programmed as a special purpose computing device(s) with one or more of the example systems and methods described herein, and/or equivalents. The example computing device may be a computer 405 that includes at least one hardware processor 410, a memory 415, and input/output ports 420 operably connected by a bus 425. In one example, the computer 405 may include LLM code generation tuning logic 430 configured to facilitate automated fine-tuning of an LLM to improve the ability of the LLM to generate software code, similar to the logic, systems, methods, and other embodiments shown in and described with reference to FIGS. 1, 2, and 3.

In different examples, the logic 430 may be implemented in hardware, one or more non-transitory computer-readable media 437 with stored instructions, firmware, and/or combinations thereof. While the logic 430 is illustrated as a hardware component attached to the bus 425, it is to be appreciated that in other embodiments, the logic 430 could be implemented in the processor 410, stored in memory 415, or stored in disk 435.

In one embodiment, logic 430 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate automated fine-tuning of an LLM to improve the ability of the LLM to generate software code. The means may also be implemented as stored computer executable instructions that are presented to computer 405 as data 440 that are temporarily stored in memory 415 and then executed by processor 410.

Logic 430 may also provide means (e.g., hardware, non-transitory computer-readable medium that stores executable instructions, firmware) for performing one or more of the disclosed functions and/or combinations of the functions.

Generally describing an example configuration of the computer 405, the processor 410 may be a variety of various processors including dual microprocessor and other multi-processor architectures. A memory 415 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 435 may be operably connected to the computer 405 via, for example, an input/output (I/O) interface (e.g., card, device) 445 and an input/output port 420 that are controlled by at least an input/output (I/O) controller 447. The disk 435 may be, for example, a magnetic disk drive, a solid-state drive, a floppy disk drive, a tape drive, a Zip drive, a flash memory card, a memory stick, and so on. Furthermore, the disk 435 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 415 can store a process 450 and/or a data 440, for example. The disk 435 and/or the memory 415 can store an operating system that controls and allocates resources of the computer 405.

The computer 405 may interact with, control, and/or be controlled by input/output (I/O) devices via the input/output (I/O) controller 447, the I/O interfaces 445, and the input/output ports 420. Input/output devices may include, for example, one or more network devices 455, displays 470, printers 472 (such as inkjet, laser, or 3D printers), audio output devices 474 (such as speakers or headphones), text input devices 480 (such as keyboards), cursor control devices 482 for pointing and selection inputs (such as mice, trackballs, touch screens, joysticks, pointing sticks, electronic styluses, electronic pen tablets), audio input devices 484 (such as microphones or external audio players), video input devices 486 (such as video and still cameras, or external video players), image scanners 488, video cards (not shown), disks 435, and so on. The input/output ports 420 may include, for example, serial ports, parallel ports, and USB ports.

The computer 405 can operate in a network environment and thus may be connected to the network devices 455 via the I/O interfaces 445, and/or the I/O ports 420. Through the network devices 455, the computer 405 may interact with a network 460. Through the network 460, the computer 405 may be logically connected to remote computers 465. Networks 460 with which the computer 405 may interact include, but are not limited to, a local area network (LAN), a wide area network (WAN), and other networks. In one embodiment, the computer 405 may access and interact with one or more large language models 490 through networks 460. Computer 405 may deliver prompts to a large language model 490 and receive LLM-generated responses (such as software code) from large language model 490 through networks 460. Computer 405 may also adjust or update configurations of large language model 490 through networks 460.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element, or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. One or more non-transitory computer-readable media that include stored thereon computer-executable instructions that when executed by at least a processor cause a computing system to:
access a collection of software code samples, wherein the software code samples includes intermixed sample code and human language description of the sample code;
generate prompts to an LLM to write code that performs as described by the human language description of the sample code;
fine-tune a large language model to generate software code based on a code generation loss function that evaluates code generated by the LLM in response to the prompts;
generate an evaluation score for performance of the tuned large language model as a code generator based on a value of the code generation loss function for second generated code; and
automatically determine to deploy the tuned large language model to a production environment for code generation in response to the evaluation score satisfying a threshold.

2. The non-transitory computer-readable medium of claim 1, further comprising computer-executable instructions that when executed by at least the processor cause the computing system to generate the code generation loss function to penalize one or more of dissimilarity of generated code with the sample code, incompleteness of the generated code, and inoperability of the generated code.

3. The non-transitory computer-readable medium of claim 1, further comprising computer-executable instructions that when executed by at least the processor cause the computing system to generate, as a component of the code generation loss function, a value of code matching loss that indicates an extent of dissimilarity between the sample code and the generated code.

4. The non-transitory computer-readable medium of claim 3, wherein the computer-executable instructions that when executed by at least the processor cause the computing system to generate a value of code matching loss further cause the computing system to:
generate a value of recall between the sample code and the generated code;
generate a value of precision between the sample code and the generated code; and
combine the values of recall and precision to produce the value of code matching loss.

5. The non-transitory computer-readable medium of claim 1, further comprising computer-executable instructions that when executed by at least the processor cause the computing system to generate, as a component of the code generation loss function, a value of non-linear code completeness loss that indicates an extent to which the generated code fails to produce expected output on a line-by-line basis.

6. The non-transitory computer-readable medium of claim 5, wherein the computer-executable instructions that when executed by at least the processor cause the computing system to generate a value of non-linear code completeness loss further cause the computing system to:
access a test case associated with the sample code;
record line-by-line outputs of executing the sample code and the generated code on the test case;
compare the outputs of corresponding individual lines of the sample code and the generated code; and
where the outputs differ for a corresponding individual line, add to the value of non-linear code completeness loss an amount based on a line number of the corresponding individual line.

7. The non-transitory computer-readable medium of claim 1, further comprising computer-executable instructions that when executed by at least the processor cause the computing system to generate, as a component of the code generation loss function, a value of unit test passing loss that indicates an extent to which the generated code fails to produce output consistent with the sample code.

8. The non-transitory computer-readable medium of claim 7, wherein the computer-executable instructions that when executed by at least the processor cause the computing system to generate a value of unit test passing loss further cause the computing system to:
access a test case associated with the sample code;
execute the sample code and the generated code on the test case;
compare results of the test case executed by the sample code and executed by the generated code; and
where the results differ, set the value of the unit test passing loss to indicate that unit test has failed.

9. The non-transitory computer-readable medium of claim 1, wherein the computer-executable instructions that when executed by at least the processor cause the computing system to generate prompts to an LLM to write code that performs as described by the human language description of the sample code further cause the computing system to:
automatically detect a coding language from the sample code; and
include the detected coding language in the prompts.

10. A computing system, comprising:
at least one processor connected to at least one memory;
one or more non-transitory computer-readable media including computer-executable instructions stored thereon that when executed by at least the processor cause the computing system to:
access a collection of software code samples, wherein the software code samples includes intermixed sample code and human language description of the sample code;
generate prompts to an LLM to write code that performs as described by the human language description of the sample code;
fine-tune a large language model to generate software code based on a code generation loss function that evaluates code generated by the LLM in response to the prompts;
generate an evaluation score for performance of the tuned large language model as a code generator based on a value of the code generation loss function for second generated code; and
automatically determine to deploy the tuned large language model to a production environment for code generation in response to the evaluation score satisfying a threshold.

11. The computing system of claim 10, wherein the computer-executable instructions further include instructions that when executed by at least the processor cause the computing system to generate, as a component of the code generation loss function, a value of code matching loss that indicates an extent of dissimilarity between the sample code and the generated code.

12. The computing system of claim 10, wherein the computer-executable instructions further include instructions that when executed by at least the processor cause the computing system to generate, as a component of the code generation loss function, a value of non-linear code completeness loss that indicates an extent to which the generated code fails to produce expected output on a line-by-line basis.

13. The computing system of claim 10, wherein the computer-executable instructions further include instructions that when executed by at least the processor cause the computing system to generate, as a component of the code generation loss function, a value of unit test passing loss that indicates an extent to which the generated code fails to produce output consistent with the sample code.

14. The computing system of claim 10, wherein the computer-executable instructions further include instructions that when executed by at least the processor cause the computing system to automatically generate one or more test cases based on Monte Carlo simulation of inputs to the sample code.

15. A computer-implemented method, comprising:
accessing a collection of software code samples, wherein the software code samples includes intermixed sample code and human language description of the sample code;
generating prompts to an LLM to write code that performs as described by the human language description of the sample code;
fine-tuning a large language model to generate software code based on a code generation loss function that evaluates code generated by the LLM in response to the prompts;
generating an evaluation score for performance of the tuned large language model as a code generator based on a value of the code generation loss function for second generated code; and
automatically signal that the fine tuning of the tuned large language model is complete in response to the evaluation score satisfying a threshold.

16. The computer-implemented method of claim 15, further comprising:
generating a value of recall between the sample code and the generated code;
generating a value of precision between the sample code and the generated code; and
combining the values of recall and precision to produce a value of code matching loss, wherein the value of code matching loss is a component of the code generation loss function.

17. The computer-implemented method of claim 15, further comprising:
generating a value of recall between the sample code and the generated code;
generating a value of precision between the sample code and the generated code; and
combining the values of recall and precision to produce a value of code matching loss, wherein the value of code matching loss is a component of the code generation loss function.

18. The computer-implemented method of claim 15, further comprising:
accessing a test case associated with the sample code;
recording line-by-line outputs of executing the sample code and the generated code on the test case;
comparing the outputs of corresponding individual lines of the sample code and the generated code;
where the outputs differ for a corresponding individual line, assign a loss amount based on a line number of the corresponding individual line; and
sum the assigned loss amounts for the individual lines to produce a value of non-linear code completeness loss, wherein the value of non-linear code completeness loss is a component of the code generation loss function.

19. The computer-implemented method of claim 15, further comprising:
accessing a set of test cases automatically generated for inputs to the sample code;
for test cases in the set of test cases,
executing the sample code and the generated code on the test case,
comparing results of the executing the sample code on the test case and the executing the generated code on the test case,
where the results differ, incrementing a tally of differing results; and
determining a ratio of the tally of differing results to a count of the test cases to produce a value of unit test passing loss, wherein the value of unit test passing loss is a component of the code generation loss function.

20. The computer-implemented method of claim 15, further comprising accessing one or more test cases.
